(19) United States
(12) Patent Application Publication
(10) Pub. No.: US 2016/0105856 A1
(43) Pub. Date: Apr. 14, 2016

(54) DISABLING WIRELESS CHANNEL RECONFIGURATION REQUESTS

(71) Applicant: QUALCOMM Incorporated, San Diego, CA (US)

(72) Inventors: Shuyang YIN, Beijing (CN); Heng ZHOU, San Diego, CA (US); Xiaochen CHEN, Beijing (CN); Daowei LIN, Beijing (CN)

(21) Appl. No.: 14/737,425

(22) Filed: Jun. 11, 2015

Related U.S. Application Data
(60) Provisional application No. 62/061,632, filed on Oct. 8, 2014.

(51) Int. Cl. H04W 52/36; H04W 24/10; H04L 12/26

(52) U.S. Cl. CPC H04W 52/367; H04L 43/16; H04W 24/10

(57) ABSTRACT

A method of wireless communication includes a user equipment determining a current transmit power. The method also includes the user equipment disabling a request for an increased data rate when the current transmit power is greater than or equal to a power threshold. In some cases, the request for the increased data rate includes transmitting an event 4A measurement report.

### CROSS REFERENCE TO RELATED APPLICATION

This application claims the benefit under 35 U.S.C. §119(e) to U.S. Provisional Patent Application No. 62/061,632, entitled “DISABLING CHANNEL RECONFIGURATION REQUESTS,” filed on Oct. 8, 2014, the disclosure of which is expressly incorporated herein by reference in its entirety.

### BACKGROUND

1. Field

Aspects of the present disclosure relate generally to wireless communication systems, and more particularly, disabling a wireless channel reconfiguration request when the current transmit power is greater than or equal to a power threshold.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect of the present disclosure, a method of wireless communication is disclosed. The method includes determining a current transmit power. The method also includes disabling a request for an increased data rate when the current transmit power is greater than or equal to a power threshold.

Another aspect of the present disclosure is directed to an apparatus including means for determining a current transmit power. The apparatus also includes means for disabling a request for an increased data rate when the current transmit power is greater than or equal to a power threshold.

In another aspect of the present disclosure, a computer program product for wireless communications in a wireless network is disclosed. The computer program product has a non-transitory computer-readable medium with non-transitory program code recorded thereon. The program code is executed by a processor and includes program code to determine a current transmit power. The program code also includes program code to disable a request for an increased data rate when the current transmit power is greater than or equal to a power threshold.

Another aspect of the present disclosure is directed to an apparatus for wireless communications in a wireless network having a memory and one or more processors coupled to the memory. The processor(s) is configured to determine a current transmit power. The processor(s) is also configured to disable a request for an increased data rate when the current transmit power is greater than or equal to a power threshold.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a nodeB in communication with a UE in a telecommunications system.

FIG. 4 is a flow diagram illustrating enabling/disabling of channel reconfiguration according to an aspect of the present disclosure.

FIG. 5 is a flow diagram illustrating a method for disabling channel reconfiguration according to one aspect of the present disclosure.

FIG. 6 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

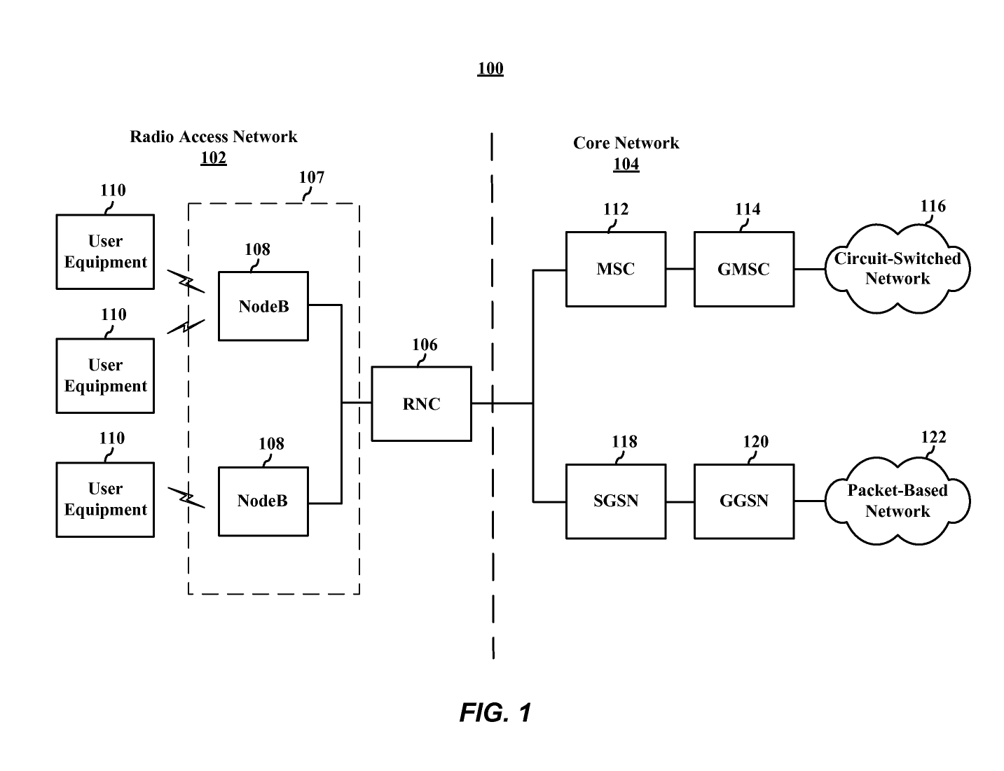

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a nodeB in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two nodeBs 108 are shown; however, the RNS 107 may include any number of wireless nodeBs. The nodeBs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the nodeBs 108. The downlink (DL), also called the forward link, refers to the communication link from a nodeB to a UE, and the uplink (UL), also called the reverse link, refers to the communication link from a UE to a nodeB.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for general packet radio service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a nodeB 108 and a UE 110, but divides uplink and downlink transmissions into different time slots in the carrier.

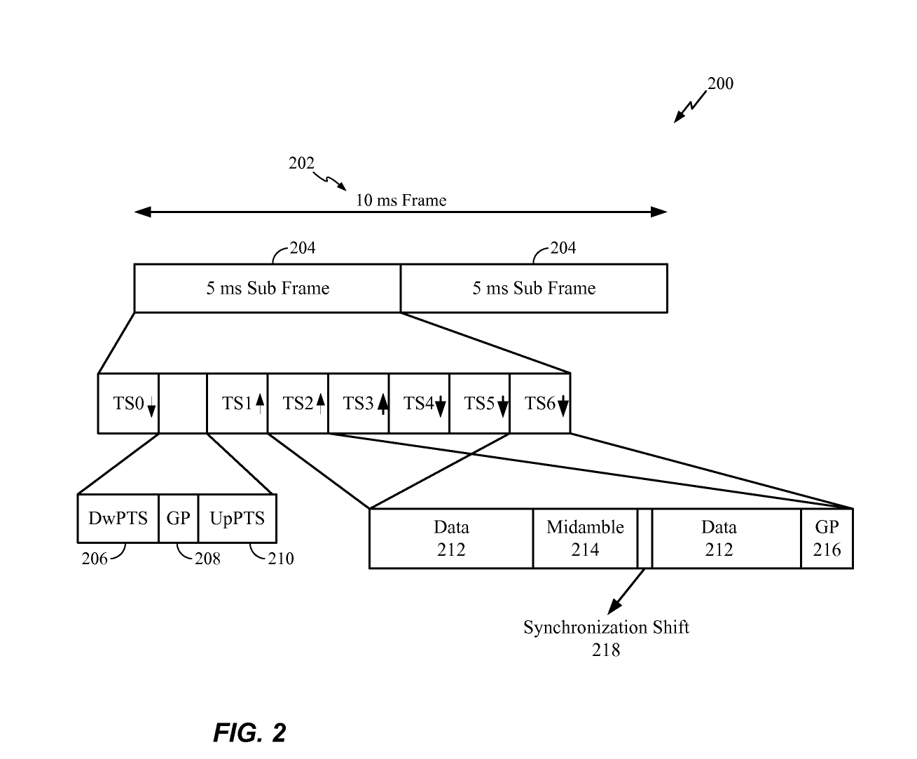

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including synchronization shift (SS) bits 218. Synchronization shift bits 218 only appear in the second part of the data portion. The synchronization shift bits 218 immediately following the midamble can indicate three cases: decrease shift, increase shift, or do nothing in the upload transmit timing. The positions of the synchronization shift bits 218 are not generally used during uplink communications.

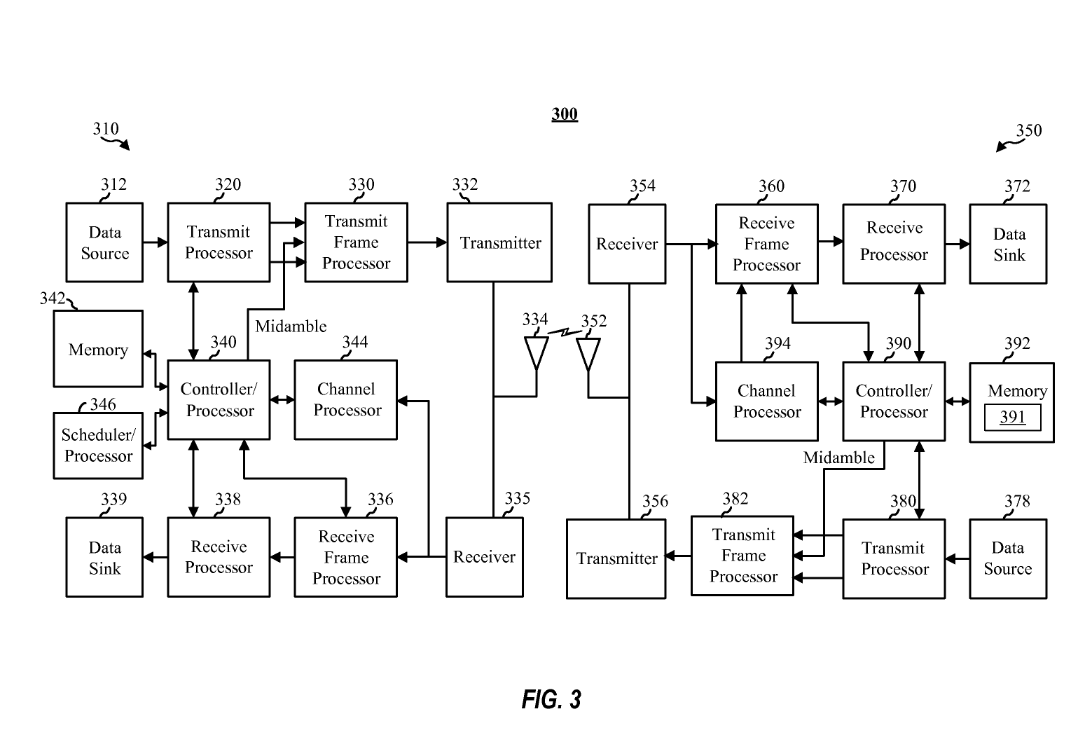

FIG. 3 is a block diagram of a nodeB 310 in communication with a UE 350 in a RAN 300, where the RAN 300 may be the RAN 102 in FIG. 1, the nodeB 310 may be the nodeB 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the nodeB 310. More specifically, the receive processor 370 descrambles and despreads the symbols, and then determines the most likely signal constellation points transmitted by the nodeB 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the nodeB 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the nodeB 310 or from feedback contained in the midamble transmitted by the nodeB 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the nodeB 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames. Additionally, a scheduler/processor 346 at the nodeB 310 may be used to allocate resources to the UEs and schedule downlink and/or uplink transmissions for the UEs.

The controller/processors 340 and 390 may be used to direct the operation at the nodeB 310 and the UE 350, respectively. For example, the controller/processors 340 and 390 may provide various functions including timing, peripheral interfaces, voltage regulation, power management, and other control functions. The computer-readable media of memory 392 may store data and software for the UE 350. For example, the memory 392 of the UE 350 may store a disabling module 391 which, when executed by the controller/processor 390, configures the UE 350 for disabling a channel reconfiguration request for an increased data rate.

### Disabling Channel Reconfiguration Requests

In a conventional network, such as a TD-SCDMA network, periodic reporting and/or event triggered reporting may be specified. For both types of reporting, a measurement report is sent by the UE based on a specific condition. For example, the periodic reporting may occur at particular time intervals, such as once every frame. Additionally, the event triggered reporting may occur when a predefined triggering condition is satisfied.

In one example, event measurement reporting, such as event 4A measurement reporting, is triggered when a traffic volume, such as the transport channel traffic volume (TCTV), is greater than a threshold. In this example, the UE sends a measurement report to obtain an increased transmission rate to satisfy the increased traffic volume. That is, the event 4A measurement report may trigger a channel reconfiguration to support transmissions at an increased data rate.

Still, in some cases, the UE transmit power may not be able to support the increased data rate. That is, the increased data rate may not be supported when the UE transmit power reaches a power limit, such as the maximum transmit power limit (MTPL). Thus, in some cases, the transmission of a measurement report may cause a potential radio link failure after the channel reconfiguration. The potential radio link failures may increase a call drop rate.

Aspects of the present disclosure are directed to disabling a request for an increased data rate, such as a transmission of an event 4A measurement report, based on various criteria. For example, when the UE transmit (Tx) power is within a threshold of a power limit, such as the maximum transmit power limit (MTPL), the request for the increased data rate is disabled for a period time. In one configuration, the request for the increased data rate is disabled until the transmit power is less than a power threshold. Additionally, or alternatively, a request for the increased data rate is disabled or enabled based on whether transmit power is less than or greater than the power threshold for a specific period of time (e.g., a predetermined period of time). In one configuration, the power threshold is a specific power level that is less than a power limit, such as the maximum transmit power limit. For example, the power threshold may be calculated as (MTPL-X) dBm, where X is a predetermined value that is static or dynamically determined

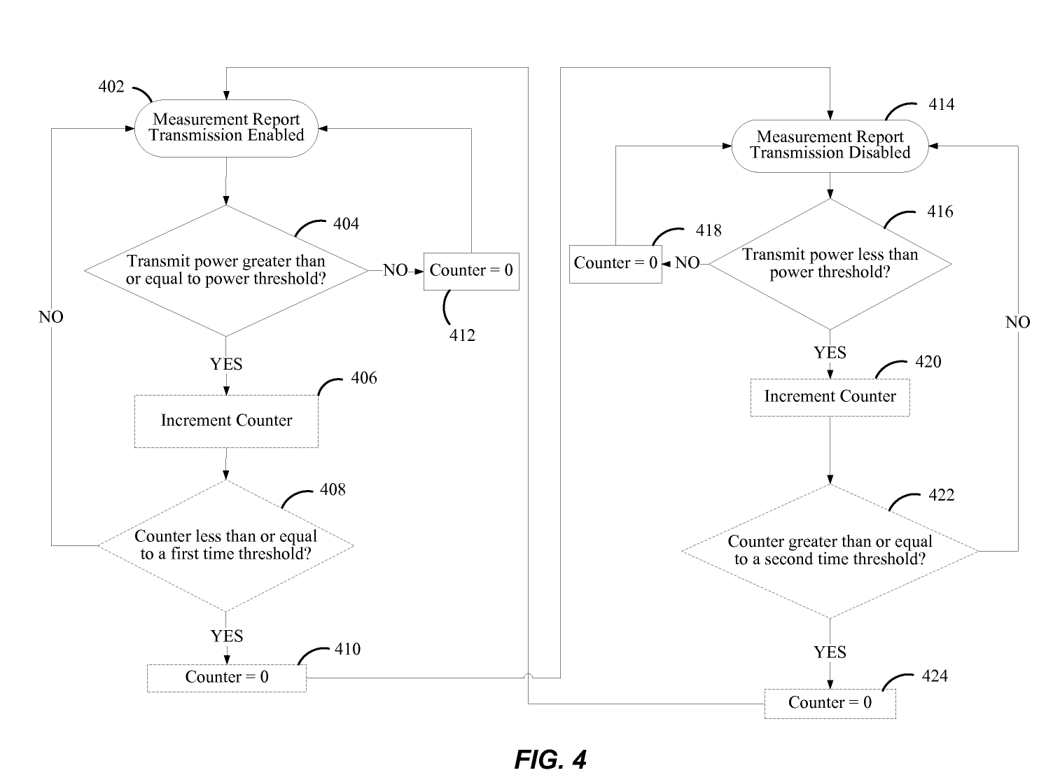

FIG. 4 illustrates a flow diagram 400 of an example for disabling or enabling a request for the increased data rate based on the transmit power. The flow diagram 400 of FIG. 4 begins with either block 402 where the request for an increased data rate is enabled or block 414 where the request for an increased data rate is disabled. In this example, a measurement report, such as the event 4A measurement report, is transmitted as a request for an increased data rate. Thus, disabling the transmission of the measurement report disables the request for an increased data rate. Alternatively, enabling the transmission of the measurement report enables the request for an increased data rate.

The flow diagram 400 may be performed once at every frame. For illustrative purposes, the description of FIG. 4 will begin at block 402, such that the transmission of a measurement report is enabled at the current frame. Still, as previously discussed, the current frame begins at either block 402 or block 414, based on whether a measurement report is disabled or enabled for the current frame. Additionally, aspects of the present disclosure are not limited to determining, at each frame, whether to enable or disable the request of an increased data rate. Aspects of the present disclosure are also contemplated for other time periods, such as once every other frame or once every two frames.

As shown in FIG. 4, after determining, at block 402, that that the transmission of a measurement report is enabled at the current frame, at block 404, the UE determines whether the current transmit power is greater than or equal to a power threshold. As previously discussed, the power threshold is transmit power that is within a predetermined amount (X dBm) from the maximum transmit power level. That is, the power threshold is the difference of the maximum transmit power level and the predetermined amount. In this example, if the current transmit power is less than the power threshold, the UE sets a counter to zero, at block 412, and returns to block 402, such that the transmission of the measurement report remains enabled.

As previously discussed, the transmission of the measurement report may be disabled or enabled based on whether the current transmission power is greater than or less than a threshold for a period of time. In one configuration, the counter is used to determine the period of time for which the transmit power has been greater than or less than the power threshold. In this configuration, the period of time is a specific number of frames. Still, the period of time is not limited to a number of frames and may be determined from other time measurements.

Alternatively, if the current transmit power is greater than the power threshold, the UE increments the counter at block 406. Additionally, at block 408, the UE determines whether the counter is less than a first time threshold. In this example, the first time threshold is a time period, such as a number of frames. Accordingly, if the transmit power has been greater than the power threshold for a time period that is greater than or equal to a specific time period (e.g., first time threshold), then the transmission of the measurement report is disabled. Alternatively, if the transmit power has been less than the power threshold for a time period that is less than a specific time period, then the transmission of the measurement report may remain enabled.

Thus, as shown in FIG. 4, at block 408, if the counter is less than a first time threshold, the transmission of the measurement report remains enabled (block 402). Alternatively, at block 408, if the counter is greater than or equal to a first time threshold, the UE sets the counter to zero at block 410. Furthermore, after setting the counter to zero (block 410), the UE disables transmission of the measurement report at block 414.

In this configuration, the transmission is disabled for the current frame. That is, the decision to enable or disable the transmission of the measurement report occurs once a frame. Moreover, the power level may remain at the same level for a frame. Thus, even if the decision to enable or disable the transmission of the measurement report occurred more than once a frame, the decision would remain the same throughout the frame because the power level remains the same during the frame.

Furthermore, as shown in FIG. 4, a UE may determine, at block 414, that the transmission of the measurement report is disabled at the current frame. After determining that the transmission of the measurement report is disabled, the UE determines if the current transmit power is less than the power threshold, at block 416. As shown in FIG. 4, if the current transmit power is greater than or equal to the power threshold, the UE sets the counter to zero (block 418) and the transmission of the measurement report remains disabled (block 414). Alternatively, if the current transmit power is less than the power threshold, at block 420 the UE increments the counter. Furthermore, at block 422 the UE determines if the counter is greater than or equal to a second time threshold.

In this example, the second time threshold is a time period, such as a number of frames. Accordingly, if the transmit power has been less than the power threshold for a time period that is shorter than a specific time period (e.g., second time threshold), then the transmission of the measurement report remains disabled. Alternatively, if the transmit power has been less than the power threshold for a time period that is longer than or equal to the specific time period, then the transmission of the measurement report may be enabled.

Thus, as shown in FIG. 4, at block 422, if the counter is less than a second time threshold, the transmission of the measurement report remains disabled (block 414). Alternatively, at block 422, if the counter is greater than or equal to the second time threshold, the UE sets the counter to zero at block 424. Furthermore, after setting the counter to zero (block 424), the UE enables transmission of the measurement report at block 402. In one configuration, the transmission of the measurement report is enabled for the current frame, such that subsequent frames may evaluate the power level to determine if the transmission of the measurement report should be enabled or disabled at the given frame.

In one configuration, the disabling or enabling of the measurement report transmission begins at the physical layer (i.e., layer 1). That is, a physical layer may determine whether the transmit power is less than or greater than a power threshold. Furthermore, the physical layer may inform another layer, such as the radio resource control (RRC) layer, to disable or to enable the transmission of the measurement report.

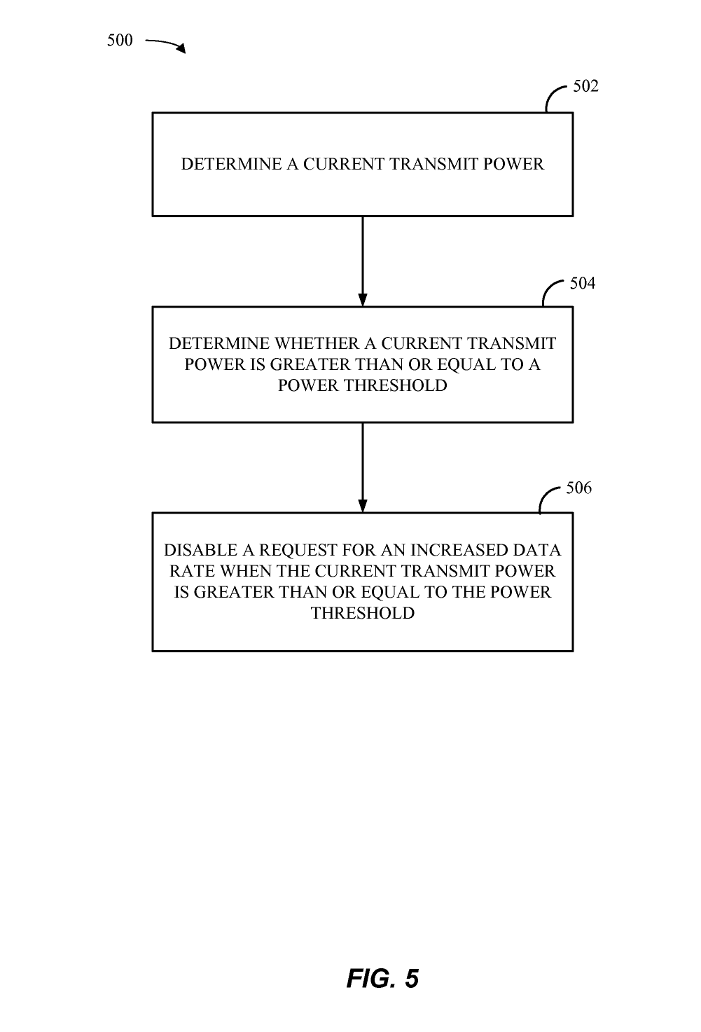

FIG. 5 shows a wireless communication method 500 according to one aspect of the disclosure. At block 502, a UE determines a current transmit power. Furthermore, at block 504, the UE determines whether a current transmit power is greater than or equal to a power threshold, as shown in block 502. Additionally, the UE disables a request for an increased data rate when the current transmit power is greater than or equal to the power threshold, as shown in block 506.

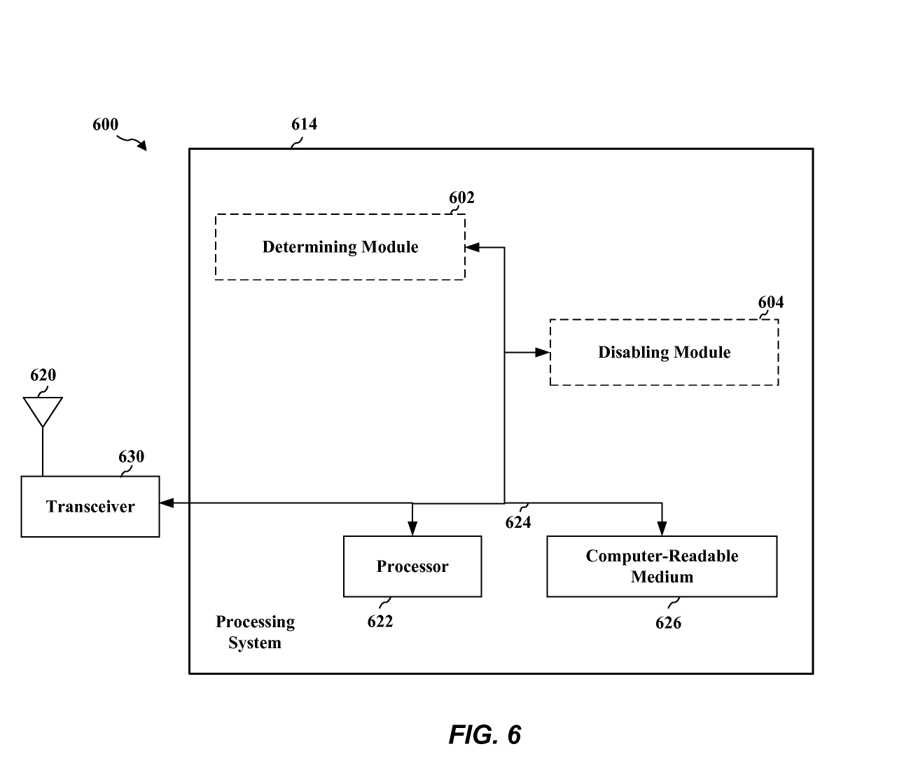

FIG. 6 is a diagram illustrating an example of a hardware implementation for an apparatus 600 employing a processing system 614. The processing system 614 may be implemented with a bus architecture, represented generally by the bus 624. The bus 624 may include any number of interconnecting buses and bridges depending on the specific application of the processing system 614 and the overall design constraints. The bus 624 links together various circuits including at least one processor and/or hardware modules, represented by the processor 622 the modules 602, 604, and the non-transitory computer-readable medium 626. The bus 624 may also link various other circuits such as timing sources, peripherals, voltage regulators, and power management circuits, which are well known in the art, and therefore, will not be described any further.

The apparatus includes a processing system 614 coupled to a transceiver 630. The transceiver 630 is coupled to one or more antennas 620. The transceiver 630 enables communicating with various other apparatus over a transmission medium. The processing system 614 includes a processor 622 coupled to a non-transitory computer-readable medium 626. The processor 622 is responsible for general processing, including the execution of software stored on the computer-readable medium 626. The software, when executed by the processor 622, causes the processing system 614 to perform the various functions described for any particular apparatus. The computer-readable medium 626 may also be used for storing data that is manipulated by the processor 622 when executing software.

The processing system 614 includes a determining module 602 for determining a current transmit power. Additionally, the determining module 602 may be configured to determine whether a current transmit power is greater than or less than a power threshold. The processing system 614 includes a disabling module 604 for disabling a request for an increased data rate when a current transmit power is less than or equal to the power threshold. The modules may be software modules running in the processor 622, resident/stored in the computer-readable medium 626, one or more hardware modules coupled to the processor 622, or some combination thereof. The processing system 614 may be a component of the UE 350 and may include the memory 392, and/or the controller/processor 390.

In one configuration, an apparatus, such as a UE, is configured for wireless communication including means for determining In one aspect, the determining means may be the transmit frame processor 382, the transmit processor 380, the controller/processor 390, the memory 392, the determining module 602 and/or the processing system 614 configured to perform the determining means. The UE is also configured to include means for disabling. In one aspect, the disabling means may be the channel processor 394, the transmit frame processor 382, the transmit processor 380, the controller/processor 390, the memory 392, the disabling module 391, and/or the processing system 614 configured to perform the disabling means. In one configuration, the means functions correspond to the aforementioned structures. In another aspect, the aforementioned means may be a module or any apparatus configured to perform the functions recited by the aforementioned means.

In another aspect, an apparatus, configured for wireless communication may also include means for enabling a request for increased data rate. In one aspect, the enabling means may be the controller/processor 390, the memory 392, and/or the processing system 614 configured to perform the enabling means. The apparatus may also be configured to include means for periodically determining whether the current transmit power is greater than or equal to a power threshold. In one aspect, the periodically determining means may be the controller/processor 390, the memory 392, and/or the processing system 614 configured to perform the periodically determining means.

Several aspects of a telecommunications system has been presented with reference to TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

It is also to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
determining, at a UE (user equipment), a current transmit power; and
disabling, at the UE, a request for an increased data rate when the current transmit power is greater than or equal to a power threshold.

2. The method of claim 1, in which the request for the increased data rate comprises transmitting an event 4A measurement report.

3. The method of claim 1, further comprising disabling the request when the current transmit power remaining is greater than the power threshold for a predetermined period of time.

4. The method of claim 1, further comprising enabling the request for the increased data rate when the current transmit power is less than the power threshold.

5. The method of claim 4, further comprising enabling the request when the current transmit power remains less than the power threshold for a predetermined period of time.

6. The method of claim 1, further comprising periodically determining whether the current transmit power is greater than or equal to the power threshold.

7. The method of claim 1, in which the power threshold is a difference of a maximum transmit power and a predetermined amount.

8. An apparatus for wireless communication, the apparatus comprising:
means for determining, at a UE (user equipment), a current transmit power; and
means for disabling, at the UE, a request for an increased data rate when the current transmit power is greater than or equal to a power threshold.

9. The apparatus of claim 8, in which the request for the increased data rate comprises transmitting an event 4A measurement report.

10. The apparatus of claim 8, further comprising means for disabling the request when the current transmit power remaining is greater than the power threshold for a predetermined period of time.

11. The apparatus of claim 8, further comprising means for enabling the request for the increased data rate when the current transmit power is less than the power threshold.

12. The apparatus of claim 11, further comprising means for enabling the request when the current transmit power remains less than the power threshold for a predetermined period of time.

13. The apparatus of claim 8, further comprising means for periodically determining whether the current transmit power is greater than or equal to the power threshold.

14. The apparatus of claim 8, in which the power threshold is a difference of a maximum transmit power and a predetermined amount.

15. An apparatus for wireless communication, the apparatus comprising:
a memory; and
at least one processor coupled to the memory, the at least one processor configured:
to determine a current transmit power; and
to disable a request for an increased data rate when the current transmit power is greater than or equal to a power threshold.

16. The apparatus of claim 15, in which the request for the increased data rate comprises transmitting an event 4A measurement report.

17. The apparatus of claim 15, in which the at least one processor is further configured to disable the request when the current transmit power remaining is greater than the power threshold for a predetermined period of time.

18. The apparatus of claim 15, in which the at least one processor is further configured to enable the request for the increased data rate when the current transmit power is less than the power threshold.

19. The apparatus of claim 18, in which the at least one processor is further configured to enable the request when the current transmit power remains less than the power threshold for a predetermined period of time.

20. The apparatus of claim 15, in which the at least one processor is further configured to periodically determine whether the current transmit power is greater than or equal to the power threshold.

21. The apparatus of claim 15, in which the power threshold is a difference of a maximum transmit power and a predetermined amount.

22. A computer program product for wireless communications, the computer program product comprising:
a non-transitory computer-readable medium having program code recorded thereon, the program code being executed by a processor and comprising:
program code to determine, at a UE (user equipment), a current transmit power; and
program code to disable, at the UE, a request for an increased data rate when the current transmit power is greater than or equal to a power threshold.

23. The computer program product of claim 22, in which the request for the increased data rate comprises transmitting an event 4A measurement report.

24. The computer program product of claim 22, in which the program code further comprises program code to disable the request when the current transmit power remaining is greater than the power threshold for a predetermined period of time.

25. The computer program product of claim 22, in which the program code further comprises program code to enable the request for the increased data rate when the current transmit power is less than the power threshold.

26. The computer program product of claim 25, in which the program code further comprises program code to enable the request when the current transmit power remains less than the power threshold for a predetermined period of time.

27. The computer program product of claim 22, in which the program code further comprises program code to periodically determine whether the current transmit power is greater than or equal to the power threshold.

28. The computer program product of claim 22, in which the power threshold is a difference of a maximum transmit power and a predetermined amount.
